(19) United States
(12) Patent Application Publication
(10) Pub. No.: US 2005/0032915 A1
(43) Pub. Date: Feb. 10, 2005

(54) Metallic colloid and functional material produced therefrom

(75) Inventors: Hirofumi Nakagawa, Hiratsuka-shi (JP); Masayuki Saito, Hiratauka-shi (JP)

Correspondence Address: Richard S. Roberts;ROBERTS & ROBERTS, L.L.P., P.O. Box 484, Princeton, NJ, 08542-0484, US

(73) Assignee: Tanaka Kikinzoku Kogyo K.K

(21) Appl. No.: 10/912,456

(22) Filed: Aug. 5, 2004

(30) Foreign Application Priority Data
Aug. 6, 2003 (JP) P2003-287278

(51) Int. Cl. B01F 3/04

(52) U.S. Cl. 516/4

(57) ABSTRACT

A metallic colloid used in the production of various functional materials including catalytic materials, optical materials, electric materials and magnetic materials. The metallic colloid contains a solvent selected from water or a mixed solvent of water and an organic solvent; cluster particles comprising one or more metals or metal oxides; and a protective agent for protecting the cluster particles. The protective agent is an organic compound comprising carbon, and at least any one of nitrogen, oxygen and hydrogen. The organic compound is evaporable or sublimable at a temperature of 200° C. or below.

### BACKGROUND OF THE INVENTION

1. Field of the Invention

The present invention relates to a metallic colloid used in the production of various functional materials including catalytic materials, optical materials, electric materials and magnetic materials.

2. Description of the Related Art

A metallic colloid means a condition in which microparticles (cluster particles) of 1 to 100 nm in particle size of a metal, a ceramic or the like are dispersed or suspended in a medium; generally known is a metallic colloid in which a liquid is used as the medium. In these years, metallic colloids have been investigated with respect to the application thereof to the production of functional materials in various fields involving catalytic, optical, electric and magnetic materials.

The techniques invoked in the production of the various materials by employing metallic colloids includes that a metallic colloid solution is adsorbed on a support and then the target material is obtained by drying or sintering. More specifically, in the production of a catalyst, where the support is an article generally referred to as a carrier, a metallic colloid is absorbed on a porous material including alumina or carbon, and the porous material thus treated is subjected to sintering, consequently permitting producing a catalyst in which fine cluster particles are highly dispersed. Additionally, in the fields of optical, electric and magnetic materials, where the supports are structure bodies (substrates or powders) each comprising a polymer material, a metal, glass, a ceramic and the like, the metallic colloids are applied or adsorbed to the supports, and thereafter, the supports thus treated are dried and sintered, permitting producing various functional materials in which the cluster particles are provided as thin films formed on and fixed to the supports.

The present inventors have hitherto investigated metallic colloids applicable to the production of the above described various functional materials, and have investigated a metallic colloid in which cluster particles composed of one or more types of metals are protected with a protective agent composed of a polymer such as polyvinyl pyrrolidone (hereinafter referred to as PVP) and a quaternary ammonium salt (see Japanese Patent Laid-Open Nos. Hei 11-151436, 2000-279818 and 2002-001095). Here, a protective agent means a compound which is chemically or physically bonded and adsorbed to the periphery of the cluster particles in the metallic colloid, and thus suppresses the mutual agglomeration of the cluster particles, regulates the particle size distribution to fall within an appropriate range and accordingly stabilizes the colloid. In other words, the addition of the protective agent retains the condition in which the cluster particles of small particle sizes are suspended, and thus, in the production of a catalyst, the particle size of the catalyst particles can be made small, so that the effective surface area of the catalyst can be made as large as possible. Additionally, as for the electric and electronic materials, the application of a composite metallic colloid comprising the cluster particles composed of a plurality of metals makes it possible to obtain a thin film in which two or more metals are highly dispersed, and hence it is expected that highly functional materials can be produced.

Now, when various materials are produced by taking advantage of an above described conventional metallic colloid, in order to remove the protective agent on the support after the metallic colloid is adsorbed or applied on the support, it is necessary to heat the support at a high temperature (200° C. or above); however, this is accompanied by the following problems.

Among others, there is a problem of damaging a catalyst support in the production of a catalyst. For example, when a carbon support is used, if sintering is carried out at a high temperature (about 450° C. or above) after adsorption of a metallic colloid, the protective agent is burnt out and at the same time the carbon support is also burnt and thereby damaged. In this case, if the sintering is carried out in an inert atmosphere of nitrogen or the like, the damage of the support can be conceivably avoided; however, carbon ascribable to the protective agent remains on the surface of the metal on the support, adversely affecting the activity of the catalyst produced. Additionally, sintering at a high temperature affects the production efficiency of the catalyst. This type of sintering causes surface oxidization depending on the type of the metallic colloid (type of metal); more specifically, for example, as in the case of ruthenium, sintering at a high temperature after adsorption causes the surface oxidization depending on the type (of metal element) of the metallic colloid. Accordingly, it is necessary to remove the oxide coating film by hydrogen reduction after sintering as the case may be, and the number of the steps for producing the catalyst is thereby increased. Furthermore, sintering at a high temperature affects the catalytic activity under a relation that the interaction between the carrier and the metal is weak; for example, when carbon is used for the carrier, and the carrier is made to adsorb a palladium colloid and then sintered, mutual sintering of the metal particles is caused by the sintering at a high temperature, adversely affecting the dispersibility of the catalyst particles and hence degrading the activity thereof.

Also in the fields of the optical, electric and magnetic materials, sintering at a high temperature causes the problem of damaging the supports. As the supports for these materials, frequently applied are polymer materials and glass; however, when the sintering temperature exceeds the decomposition temperatures or the glass transition temperatures of these materials, the fracture or softening of the support is induced, so that they cannot be used as the target materials.

As mentioned above, sintering at a high temperature offers problems to any of the uses. Moreover, primarily, a heat treatment at a high temperature causes the rise of the production cost for various types of materials, and is not preferable. The present invention has been achieved on the basis of the above described backgrounds and takes as its object the provision of a metallic colloid for which the removal of the protective agent after adsorption or application to the support can be carried out at low temperatures (200° C. or below).

### SUMMARY OF THE INVENTION

The invention provides a metallic colloid comprising: a solvent selected from water or a mixed solvent of water and an organic solvent; cluster particles comprising one or more metals or metal oxides; and a protective agent for protecting said cluster particles, wherein said protective agent is an organic compound comprising carbon, and at least any one selected from a the group consisting of nitrogen, oxygen and hydrogen, said organic compound being evaporable or sublimable at a temperature of 200° C. or below.

The present inventors have considered, as a result of investigation, that the reason that the above-described protective agent applied in a conventional metallic colloid can be removed only at high temperatures is ascribable to the fact that the protective agent exhibits no volatility at low temperatures. In this connection, polymers such as PVP exhibit no vapor pressure because of being polymers, and are hardly removable at low temperatures. Additionally, a quaternary ammonium salt is also difficult to be removed at low temperatures because of being salt and accordingly having no volatility, although the molecular weight of the ammonium salt is low. Additionally, the other hitherto known protective agents for metallic colloids exhibit no volatility for the same reasons.

Thus, the present inventors have considered that as a metallic colloid capable of solving the above described problems, preferable is a metallic colloid for which the protective agent exhibits volatility at a temperature not higher than a predetermined temperature, and thus have thought up the present invention.

The present invention is a metallic colloid comprising a solvent composed of water or a mixed solvent composed of water and an organic solvent, cluster particles comprising one or more types of metals or metal oxides, and a protective agent for protecting the above described cluster particles, wherein the protective agent is an organic compound comprising at least any one selected from a group consisting of carbon, nitrogen, oxygen and hydrogen, and no other atoms being evaporable or sublimable at a temperature of 200° C. or below.

Here, the reason for constraining the protective agent to be an organic compound comprising at least merely any of carbon, nitrogen, oxygen and hydrogen is based on the apprehension that an organic compound, comprising the elements other than carbon, nitrogen, oxygen and hydrogen, highly probably remains on the support even when heated at a low temperature, and if it is the case, the functions as a catalyst and the like will be degraded.

In this connection, the present inventors have made investigation on those compounds which exhibit the above described characteristics and the functions as a protective agent itself, and eventually have found that the amine oxides represented by the following formula are preferable: 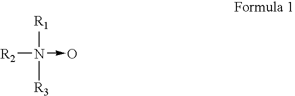
wherein each of R₁, R₂ and R₃ are independently hydrogen or an organic substituent, i.e. a carbon containing substituent.

Preferably each of R₁, R₂ and R₃ are independently hydrogen, or a carbon containing substituent, provided at least one of R₁, R₂ and R₃ is a carbon containing substituent.

More preferably each of R₁, R₂ and R₃ are independently hydrogen, a C₁ to C₁₈ alkyl group or a C₁ to C₁₈ alkoxy group, provided at least one of R₁, R₂ and R₃ is a C₁ to C₁₈ alkyl group or a C₁ to C₁₈ alkoxy group.”

The amine oxides exhibit volatility at a temperature of 200° C. or below. Accordingly, according to the present invention and the like, the amine oxides can be removable even by heat treatment at relatively low temperatures. Additionally, the amine oxides also have properties required for the protective agent for metallic colloids. More specifically, the amine oxides can protect the cluster particles in the solvent in such a way that they are not agglomerated, so that their dispersibility can be maintained until they are adsorbed to the support. Therefore, according to the metallic colloid according to the present invention, similarly to the metallic colloids hitherto known, fine cluster particles can be immobilized on the support while the dispersibility of the cluster particles is maintained, and the heat treatment temperature can be made lower.

As for the substituents R₁, R₂ and R₃ of the amine oxides, it is preferable that the combination of these substituents results in the total number of the carbon, oxygen and nitrogen atoms contained in these substituents falling within the range from 3 to 20. This is because those amine oxides for which the above described total number is less than 3 are weak in the van der Waals forces between the alkyl chains, become unstable on the surface of the cluster particles, and thus are poor in the ability for dispersing the cluster particles. This is also because those amine oxides for which the above described total number exceeds 20 are large in molecular weight and hence can hardly be evaporated at 200° C. or below.

Specific examples of the amine oxides preferable as the protective agent include dimethyl lauryl amine oxide, methyl myristyl amine oxide, dimethyl stearyl amine oxide, di(hydroxyethyl) lauryl amine oxide, di(hydroxyethyl) amine oxide, dimethyl lauryl ethoxy amine oxide, dimethyl allyl amine oxide, dimethyl ethyl amine oxide, dimethyl propyl amine oxide, dimethyl butyl amine oxide, dimethyl pentyl amine oxide, methyl hexyl amine oxide, dimethyl octyl amine oxide, and dimethyl decyl amine oxide.

Additionally, preferable as the metals and metal oxides constituting the cluster particles, are gold, platinum, silver, palladium, rhodium, iridium, ruthenium and osmium, and the oxides of these metals. Additionally, the cluster particles may comprise only one of these metals or metal oxides, but may also comprise two or more of these metals. Furthermore, the types of the metals or metal species constituting the cluster particles are not restricted to precious metals, but may be base metals. For example, in the field of catalyst, catalysts have been developed in which precious metals are supported as catalyst metal for catalytic reactions, and metals other than precious metals including alkali earth metals such as barium, rare earth metals such as cerium and transition metals are supported together in a complex manner as promoter metal for the purpose of improving activity, suppressing particle growth, suppressing catalyst poisoning and the like. The metallic colloid according to the present invention can be applied to the above described catalysts by applying cluster particles comprising precious metals (oxides) and base metals (oxides).

Additionally, as the solvent, water or a mixed solvent composed of water and an organic solvent can be applied. As the organic solvent, alcohols such as ethanol, ketones such as acetone and esters such as ethyl acetate can be applied.

It is preferable in principle that the method for preparing the metallic colloid according to the present invention is based on the reduction method hitherto well known as a method for preparing a metallic colloid. In the reduction method, the metal salt of the metal which constitutes the cluster particles is dissolved in a solvent to be ionized, then a protective agent and a reducing agent are added to the solution thus obtained to reduce the metal ions into cluster particles and to simultaneously protect the cluster particles with the aid of the protective agent. The protective agent may be dissolved simultaneously with the metal salt. For the purpose of dispersing cluster particles comprising two or more metals, the purpose can be attained by dissolving two or more metal salts in a solvent.

The metal salts to be used as the source materials are described below. As the metal salts to be used for preparation of the platinum colloid, hexachloroplatinic acid, dinitrodiammineplatinum, dinitrodiammineplatinum nitrate, platinous chloride, platinic chloride, chloroplatinic acid, chloroplatinate and the like can be applied. As the metal salts to be used for preparation of the palladium colloid, palladium chloride, palladium nitrate, dinitrodiamminepalladium and the like can be applied. As the metal salts to be used for preparation of the gold colloid, chloroauric acid, chloroaurate, potassium tetracyanoaurate, potassium cyanoaurate and the like can be applied. As the metal salts to be used for preparation of the silver colloid, silver chlorate, silver nitrate, silver acetate, silver lactate and the like can be applied. As the metal salts to be used for preparation of the ruthenium colloid, ruthenium chloride, ruthenium nitrate and the like can be applied. As the metal salts to be used for preparation of the rhodium colloid, rhodium chloride, rhodium nitrate, rhodium acetate and the like can be applied. As the metal salts to be used for preparation of the iridium colloid, hexachloroiridic acid, iridium trichloride and the like can be applied. As the metal salts to be used for preparation of the osmium colloid, osmium oxide and the like can be applied.

Additionally, no particular constraint is imposed on the reducing agent as far as it is applicable to the chemical reduction method, and the reducing agent has only to be a compound capable of reducing the solution of the mixture of the metal salt and the protective agent. Preferable reducing agents include alcohols such as ethanol, formic acid, hydrogen, hydrazine, amines, sodium borohydride, and dimethylamine borane.

In the methods for producing various types of materials by use of the metallic colloids according to the present invention, the desired material can be produced in such a way that a metallic colloid is adsorbed and supported by a support, then the protective agent is removed through conducting a heat treatment, and the metal or the metal oxide in the cluster particles is immobilized.

The general method for adsorbing or applying of the metallic colloid to the support is that in preparation of a catalyst, a metallic colloid is impregnated into and thereby adsorbed to a porous material to be the carrier. In this case, for the purpose of improving the dispersibility of the cluster particles in the carrier, it may be possible that the carrier is beforehand dispersed in the solvent and the metallic colloid is added to the dispersion solution thus obtained. On the other hand, for the case of the fabrication of the thin films to be applied to electric and electronic materials, available are the methods in which the spin coater method, the ink jet method and the like are used to apply the metallic colloid to a support to be the substrate.

The heat treatment conducted after the metallic colloid adsorption is to be carried out at 200° C. or below, and it is preferable that the heat treatment is carried out in the atmosphere of the air or an inert gas. In particular, when the cluster particles are formed of an easily oxidizable metal, and it is necessary to avoid the oxidation of the cluster particles, it is preferable to carry out the heat treatment in the atmosphere of an inert gas such as nitrogen and argon.

Depending on the type of the metal salt to be used as the source material for the preparation of the metallic colloid and depending on the functional materials to be produced, it is preferable to conduct a treatment for removing chloride ion before the adsorption or application of the metallic colloid. The chloride ion to be the object of the pretreatment is derived from the metal salt used for the preparation of the metallic colloid; for example, in the case where chloroauric acid (HAuCl₄) is used as the source material in the preparation of a gold colloid, when chloroauric acid is dissolved in the solvent and a reducing agent is added, the hydrochloric acid (HCl) resulting from the reduction reacts with an amine oxide as the protective agent to yield a quaternary ammonium salt represented by the following formula:

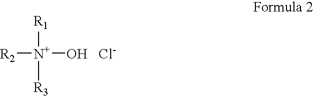

The quaternary ammonium salt does not react directly with the amine oxide or the cluster particles, but the mixing of the quaternary ammonium salt lowers the whole vapor pressure of the amine oxide. Consequently, when, as in the fabrication of thin films for electric and electronic materials, the metallic colloid is applied onto a substrate (support) and then the substrate is heated as it is, the protective agent is allowed to remain on the substrate.

Thus, when such chloride ions are generated in the metallic colloid and the metallic colloid is applied to the fabrication of thin films, it is preferable that the prepared metallic colloid is beforehand subjected to the treatment for removing chloride ion and the generation of the quaternary ammonium salt is suppressed. Applicable examples of the treatment for removing chloride ion include a method in which the metallic colloid and an ion exchange resin is mixed together, and additionally, the dialysis method based on osmosis membrane and the ultrafiltration method.

On the contrary, when the metallic colloid is impregnated into the support, thereafter the mixed solution of the colloid solution and the support is separated into the support and the solution by means of filtration and the like, as in the case of the preparation of catalysts, and subsequently the heat treatment is carried out, the adverse effect caused by the mixing of the quaternary ammonium salt is small. This can be interpreted as follows: as described above, the quaternary ammonium salt neither directly reacts with the amine oxide nor is bonded with the cluster particles; consequently, even when the metallic colloid is impregnated into the support, the cluster particles and the protective agent are adsorbed on the carrier, but the quaternary ammonium salt is not absorbed on the carrier; and thus, the filtration of the carrier after completion of supporting can remove the quaternary ammonium salt. Accordingly, the material production comprising such a step for filtration conducted after the impregnation does not need the chloride ion removal treatment.

As described above, the metallic colloid according to the present invention makes it possible to lower the temperature for the heat treatment conducted for the purpose of immobilizing the cluster particles and removing the protective agent. Thereby, oxidation of the cluster particles and deterioration of the support can be suppressed. Additionally, the heat treatment can be made either in the atmosphere of the air or in the atmosphere of an inert gas.

Additionally, the various functional materials produced on the basis of the metallic colloid according to the present invention are the articles provided with the targeted properties. For example, catalysts having highly dispersed catalyst particles and excellent in catalytic activity can be obtained; on the other hand, thin films having densely aggregating metal particles and excellent in electric properties and the like can be obtained.

### DETAILED DESCRIPTION OF THE PREFERRED EMBODIMENTS

Description will be made below on the preferred embodiments of the present invention. In the present embodiments, there were prepared metallic colloids each comprising cluster particles formed of gold, platinum or ruthenium as the metal for forming the cluster particles.

Preparation of Gold Colloid: 2.105 g of chloroauric acid (gold content: 1.05 g) and 6.7935 g of an aqueous solution of N,N-dimethyl N-lauryl amine oxide (active ingredient: 35%) as protective agent were added to 60 mL of water, and the aqueous solution thus obtained was stirred for 1 hour. 0.73 g of Diethylamine as reducing agent was added to the aqueous solution and stirred for 24 hours. Consequently, a solution of gold colloid protected by dimethyl lauryl amine oxide was able to be obtained (the gold concentration: 1.0 wt %). The metallic colloid solution was allowed to stand at room temperature for 2 weeks, but no agglomeration of the gold particles was found. This shows that the metallic colloid concerned maintained a stable dispersion condition.

Preparation of Platinum Colloid: 2.21 g of Dinitroammineplatinum nitrate was added to 90 mL of water (platinum concentration: 4.524 wt %) and 1.941 g of an aqueous solution of N,N-dimethyl N-lauryl amine oxide (active ingredient: 35%) as protective agent was added to the aqueous solution prepared above similarly to the case described above, and the aqueous solution thus obtained was stirred for 1 hour. 0.05 g of Diethylamine borane as reducing agent was added to the aqueous solution and stirred for 24 hours. Consequently, a platinum colloid protected with dimethyl lauryl amine oxide was able to be obtained. The metallic colloid solution was also allowed to stand at room temperature for 2 weeks, but no agglomeration of the platinum particles was found, and thus the stability of the platinum colloid concerned was confirmed.

Preparation of Ruthenium Colloid: 0.277 g of ruthenium acetate (ruthenium content: 0.1 g) was added to 90 mL of water and 1.941 g of an aqueous solution of N,N-dimethyl N-lauryl amine oxide (active ingredient: 35%) as protective agent was added to the aqueous solution prepared above similarly to the case described above, and the aqueous solution thus obtained was stirred for 1 hour. 0.05 g of diethylamine borane as reducing agent was added to the aqueous solution and stirred for 24 hours. Consequently, a ruthenium colloid protected with dimethyl lauryl amine oxide was able to be obtained. The metallic colloid solution was also allowed to stand at room temperature for 2 weeks, but no agglomeration of the ruthenium particles was found, and thus the stability of the ruthenium colloid concerned was confirmed.

By use of the metallic colloids prepared above, a catalyst and a thin film were produced. For the preparation of the catalyst, the above described platinum colloid was used, while for the fabrication of the thin film, the above described gold colloid was used. Additionally, for comparison, a catalyst based on a conventional PVP protected platinum colloid was also prepared.

Production of a Catalyst and Evaluation of the Properties Thereof: To 90 mL of distilled water adjusted to pH8, 9.9 g of γ-alumina was added, and fully dispersed by stirring for 30 minutes. Thereafter, the dispersion solution was added with a 5 g of solution of the platinum colloid solution protected with dimethyl lauryl amine oxide concentrated so as for the platinum concentration to be 2 wt %, and stirred intensely to make the alumina support the platinum colloid. After completion of supporting platinum, the carrier was fully dried at 110° C., heated at 200° C. for 2 hours for removing the protective agent to yield a platinum catalyst. Additionally, for comparison to this catalyst, a catalyst was prepared according to similar steps by making alumina support the PVP protected platinum colloid and heating the alumina at 200° C.

The property of the prepared platinum catalysts was evaluated on the basis of the evaluation of the decomposition rate of propylene at 180° C. The evaluation method is described more specifically as follows: a 0.4 g of platinum catalyst was weighed out and charged into a reactor; the reactor was heated to 180° C. while nitrogen gas was made to flow, and when the temperature was leveled off at 180° C., a nitrogen-oxygen-propylene gas (propylene: 495 ppm; oxygen: 2.005%) was made to pass through the reactor at a flow rate of 45.48 mL/min for 30 seconds; the discharged gas was subjected to gas chromatographic analysis for measurement of the decomposition rate of propylene.

It was confirmed from the evaluation results of the catalyst properties that the platinum catalyst prepared with the platinum colloid solution protected with dimethyl lauryl amine oxide prepared in the present embodiment exhibited a propylene decomposition rate of 90.64% and thereby exhibited a sufficiently effective property as a catalyst. On the contrary, the platinum catalyst prepared by use of a PVP protected platinum colloid with a sintering temperature of 200° C. exhibited a propylene decomposition rate as far low as 20.27%. This is based on the fact that at a sintering temperature as low as 200° C., PVP as the protective agent was not able to be removed sufficiently, and remained on the catalyst. In contrast to this, it has been confirmed that the platinum colloid solution protected with dimethyl lauryl amine oxide involved in the present embodiment can be sufficiently removed by evaporation even at 200° C., and hence the catalyst properties are not damaged.

Production of Thin Films: 100 mL of thus prepared gold colloid protected with dimethyl lauryl amine oxide (gold concentration: 1 wt %) was added with a 72 mL of commercially available anion exchange resin (Amberite® IRA 4000H, exchange capacity: 1.4 mol/L, manufactured by Organo Corp.) and stirred for 5 hours. Then the mixture was subjected to suction filtration to remove the anion exchange resin, and thus the chloride ion in the gold colloid protected with dimethyl lauryl amine oxide was removed. Then the gold colloid solution was freeze-dried to be concentrated, so that the metal concentration was adjusted to be 20 wt %. The concentrated colloid solution was applied onto the surface of a substrate (made of alumina) and dried at 200° C. to form a thin film. The formed thin film was subjected to conductivity measurement and exhibited a value of 1.67×10⁻⁷ S/m. The thin film exhibited a sufficient conductivity, so that it has been confirmed that the gold colloid protected with dimethyl lauryl amine oxide that was applied in the present case permits sufficiently removing the amine oxide even by a low temperature drying.

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto.

1. A metallic colloid comprising: a solvent selected from water or a mixed solvent of water and an organic solvent; cluster particles comprising one or more metals or metal oxides; and a protective agent for protecting said cluster particles, wherein said protective agent is an organic compound comprising carbon, and at least any one selected from the group consisting of nitrogen, oxygen and hydrogen, said organic compound being evaporable or sublimable at a temperature of 200° C. or below.

2. The metallic colloid according to claim 1, wherein the protective agent is an amine oxide represented by the following formula: 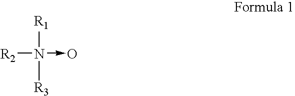
wherein each of R₁, R₂ and R₃ are independently hydrogen or an organic substituent.

3. The metallic colloid according to claim 2 wherein each of R₁, R₂ and R₃ are independently hydrogen, or a carbon containing substituent, provided at least one of R₁, R₂ and R₃ is a carbon containing substituent.

4. The metallic colloid according to claim 2 wherein each of R₁, R₂ and R₃ are independently hydrogen, a C, to C₁₈ alkyl group or a C₁ to C₁₈ alkoxy group, provided at least one of R₁, R₂ and R₃ is a C₁ to C₁₈ alkyl group or a C₁ to C₁₈ alkoxy group.

5. The metallic colloid according to claim 1, wherein the total number of the carbon, oxygen and nitrogen atoms contained in the substituents R₁, R₂ and R₃ falls within the range from 3 to 20.

6. The metallic colloid according to claim 1, wherein the protective agent is dimethyl lauryl amine oxide, methyl myristyl amine oxide, dimethyl stearyl amine oxide, di(hydroxyethyl) lauryl amine oxide, di(hydroxyethyl) amine oxide, dimethyl lauryl ethoxy amine oxide, dimethyl allyl amine oxide, dimethyl ethyl amine oxide, dimethyl propyl amine oxide, dimethyl butyl amine oxide, dimethyl pentyl amine oxide, methyl hexyl amine oxide, dimethyl octyl amine oxide, or dimethyl decyl amine oxide.

7. The metallic colloid according to claim 1, wherein the cluster particles are formed of at least one metal selected from a group consisting of gold, platinum, silver, palladium, rhodium, iridium, ruthenium and osmium, or at least one oxide selected from a group consisting of the metal oxides of those metals.

8. A method for producing a functional material comprising the steps of: adsorbing or applying the metallic colloid according to claim 1 to a support in the form of powder, plate, or bulk, and formed of a material selected from carbon, plastic, ceramic or glass; and removing the protective agent in the metallic colloid by heating the support in air or in an atmosphere of an inert gas at a temperature of 200° C. or below.

9. The method for producing a functional material according to claim 8, wherein a treatment for removing chloride ion in the metallic colloid is conducted, and then the metallic colloid is adsorbed or applied to the support.

10. The metallic colloid according to claim 2, wherein the total number of the carbon, oxygen and nitrogen atoms contained in the substituents R₁, R₂ and R₃ falls within the range from 3 to 20.

11 The metallic colloid according to claim 2, wherein the protective agent is dimethyl lauryl amine oxide, methyl myristyl amine oxide, dimethyl stearyl amine oxide, di(hydroxyethyl) lauryl amine oxide, di(hydroxyethyl) amine oxide, dimethyl lauryl ethoxy amine oxide, dimethyl allyl amine oxide, dimethyl ethyl amine oxide, dimethyl propyl amine oxide, dimethyl butyl amine oxide, dimethyl pentyl amine oxide, methyl hexyl amine oxide, dimethyl octyl amine oxide, or dimethyl decyl amine oxide.

12. The metallic colloid according to claim 5, wherein the protective agent is dimethyl lauryl amine oxide, methyl myristyl amine oxide, dimethyl stearyl amine oxide, di(hydroxyethyl) lauryl amine oxide, di(hydroxyethyl) amine oxide, dimethyl lauryl ethoxy amine oxide, dimethyl allyl amine oxide, dimethyl ethyl amine oxide, dimethyl propyl amine oxide, dimethyl butyl amine oxide, dimethyl pentyl amine oxide, methyl hexyl amine oxide, dimethyl octyl amine oxide, or dimethyl decyl amine oxide.

13. The metallic colloid according to claim 10, wherein the protective agent is dimethyl lauryl amine oxide, methyl myristyl amine oxide, dimethyl stearyl amine oxide, di(hydroxyethyl) lauryl amine oxide, di(hydroxyethyl) amine oxide, dimethyl lauryl ethoxy amine oxide, dimethyl allyl amine oxide, dimethyl ethyl amine oxide, dimethyl propyl amine oxide, dimethyl butyl amine oxide, dimethyl pentyl amine oxide, methyl hexyl amine oxide, dimethyl octyl amine oxide, or dimethyl decyl amine oxide.

14. The metallic colloid according claim 2 wherein the cluster particles are formed of at least one metal selected from a group consisting of gold, platinum, silver, palladium, rhodium, iridium, ruthenium and osmium, or at least one oxide selected from a group consisting of the metal oxides of those metals.

15. The metallic colloid according claim 5 wherein the cluster particles are formed of at least one metal selected from a group consisting of gold, platinum, silver, palladium, rhodium, iridium, ruthenium and osmium, or at least one oxide selected from a group consisting of the metal oxides of those metals.

16. The metallic colloid according claim 10 wherein the cluster particles are formed of at least one metal selected from a group consisting of gold, platinum, silver, palladium, rhodium, iridium, ruthenium and osmium, or at least one oxide selected from a group consisting of the metal oxides of those metals.

17. The metallic colloid according claim 6, wherein the cluster particles are formed of at least one metal selected from a group consisting of gold, platinum, silver, palladium, rhodium, iridium, ruthenium and osmium, or at least one oxide selected from a group consisting of the metal oxides of those metals.

18. The metallic colloid according claim 11, wherein the cluster particles are formed of at least one metal selected from a group consisting of gold, platinum, silver, palladium, rhodium, iridium, ruthenium and osmium, or at least one oxide selected from a group consisting of the metal oxides of those metals.

19. The metallic colloid according claim 12, wherein the cluster particles are formed of at least one metal selected from a group consisting of gold, platinum, silver, palladium, rhodium, iridium, ruthenium and osmium, or at least one oxide selected from a group consisting of the metal oxides of those metals.

20. The metallic colloid according claim 13, wherein the cluster particles are formed of at least one metal selected from a group consisting of gold, platinum, silver, palladium, rhodium, iridium, ruthenium and osmium, or at least one oxide selected from a group consisting of the metal oxides of those metals.
